(19) United States
(12) Patent Application Publication
(10) Pub. No.: US 2017/0093642 A1
(43) Pub. Date: Mar. 30, 2017

(54) RESOURCE PLANNING SYSTEM FOR CLOUD COMPUTING

(71) Applicant: Singapore Telecommunications Limited, Singapore (SG)

(72) Inventors: Brain Vito CHIN, Singapore (SG); Chin Kiong KOH, Singapore (SG); Guan Kian LUA, Singapore (SG); Sye Bee TEO, Singapore (SG)

(73) Assignee: Singapore Telecommunications Limited, Singapore (SG)

(21) Appl. No.: 15/258,684

(22) Filed: Sep. 7, 2016

Related U.S. Application Data
(60) Provisional application No. 62/232,792, filed on Sep. 25, 2015.

(51) Int. Cl. H04L 12/24; G06Q 20/30; H04L 29/08

(52) U.S. Cl. CPC H04L 41/14; H04L 67/22; G06Q 20/30

(57) ABSTRACT

A resource planning system is disclosed for planning reserved instance server requirements for a user of cloud computing services that comprise reserved instance servers and on-demand servers accessible by the user. The system is arranged to receive historical usage data indicative of a historical usage of the cloud computing services by a user, the historical usage data covering a defined time period including a plurality of time units, and the historical usage data including information indicative of a number of server instances that were required by the user in each time unit of the time period. The system is arranged to receive cost information indicative of cost for each reserved instance server and on-demand server, and to calculate a total cost for usage of a plurality of combinations of reserved instance servers and/or on-demand servers that will satisfy the user's server requirements over the defined time period. The system comprises a recommendation engine arranged to select a recommended number of reserved instance servers to be purchased by the user based on the calculated total cost for the plurality of combinations of reserved instance servers and on-demand servers. A corresponding method of planning reserved instance server requirements for a user of cloud computing services is also disclosed.

### CROSS REFERENCE TO RELATED APPLICATIONS

This application claims the priority benefit of U.S. Provisional Patent Application No. 62/232,792 filed on Sep. 25, 2015.

### FIELD OF THE INVENTION

The invention relates to a resource planning system for cloud computing, in particular to a resource planning system for an infrastructure as a service cloud computing service, and to a method of planning cloud computing resource requirements.

### BACKGROUND OF THE INVENTION

Cloud computing is a form of Internet based computing wherein computing services are provided to connected computers on demand through a wide area network such as the Internet. Such cloud computing services include Infrastructure as a Service (IaaS), Platform as a Service (PaaS) and Software as a Service (SaaS). laaS is a form of cloud computing that provides computing resources over a wide area network; PaaS provides a development platform to application developers over a wide area network; and SaaS provides access to application software and databases over a wide area network. Cloud computing services can be desirable to users, such as corporations, organizations and other enterprises, because it can reduce cost and also avoid or minimize the burden of installing and maintaining required local computing capability.

Typically managers of cloud computing resources charge for use of their computing resources in a variety of ways. For example, pricing may be based on reserved instance (RI) wherein a user pays for an agreed period of usage of a cloud computing server in advance, or on-demand (OD) wherein no advance payment is made and instead a user pays for use of a cloud computing server as the server is required.

An enterprise's demand for computing resources can vary drastically over time, and as a result it is difficult and costly to maintain sufficient resources to meet peak requirements. Conversely, in an effort to cut costs, if the enterprise maintains only minimal computing resources, there may not be sufficient resources to meet peak requirements.

Several resource planners for cloud computing resources are known. For example U.S. Pat. No. 8,676,622 to Ward, Jr. et al, makes note of analysis based on cost. Wang et al. (2013), “To reserve or not to reserve: Optimal online multi-instance acquisition in IaaS clouds”, Proceeding of 10th International Conference on Autonomic Computing, pp 13-22, discloses a complex algorithm for working out the most cost effective trade-off between pricing options of IaaS devices.

However, the resource planner disclosed in Wang et al would be difficult to implement and some of the cost advantages of such a process would be lost due to the cost to implement the algorithm.

### SUMMARY OF THE INVENTION

In accordance with a first aspect of the present invention, there is provided a resource planning system for planning reserved instance server requirements for a user of cloud computing services that comprise reserved instance servers and on-demand servers accessible by the user;
the system arranged to receive historical usage data indicative of a historical usage of the cloud computing services by a user, the historical usage data covering a defined time period including a plurality of time units, and the historical usage data including information indicative of a number of server instances that were required by the user in each time unit of the time period;
the system arranged to receive cost information indicative of cost for advance purchase of each reserved instance server and on-demand cost of each on-demand server; and
the system arranged to calculate a total cost for usage of a plurality of combinations of reserved instance servers and/or on-demand servers that will satisfy the user's server requirements over the defined time period; and
the system comprising a recommendation engine arranged to select a recommended number of reserved instance servers to be purchased by the user based on the calculated total cost for the plurality of combinations of reserved instance servers and on-demand servers.

In an embodiment, the recommendation engine is arranged to select a recommended number of reserved instance servers that correspond to a lowest total cost over the time period.

In an embodiment, the system is arranged to display the recommended number of reserved instance servers on a screen. The system may be arranged to highlight the recommended number of reserved instance servers on the screen.

In an embodiment, the system comprises a sync engine arranged to retrieve the historical usage data associated with a user from a cloud resource account associated with the user.

In an embodiment, the system comprises a key storage device arranged to store account access details associated with a user, the account access details usable by the sync engine to access a cloud resource account associated with the user.

In an embodiment, the system comprises a historical usage storage device arranged to store received historical usage data.

The system may comprise an analysis engine arranged to retrieve the historical usage data from the historical usage storage device and determine the total number of servers required for each time unit of the historical data.

In an embodiment, the system is arranged to determine the highest number of servers required in any time unit of the historical usage data, and to calculate the total cost for each combination of reserved instance and on-demand servers sufficient to satisfy the required number of servers in each time unit.

In an embodiment, the recommendation engine is arranged to calculate the total cost for the plurality of combinations of reserved instance servers and on-demand servers using the following equation:

TotalCost=((O−z)*Q)+(z*R)

where O is the number of servers required in a time unit of the time period of the historical usage trend Ω, (O−z)≧0, z is the number of RI servers purchased in a time unit of the time period of the historical usage trend Ω, Q is the cost of an on-demand server, and R is the cost of a reserved instance RI server.

The cloud computing services may comprise infrastructure as a service (IaaS).

In accordance with a second aspect of the present invention, there is provided a method of planning reserved instance server requirements for a user of cloud computing services that comprise reserved instance servers and on-demand servers accessible by the user, the method comprising:
receiving historical usage data indicative of a historical usage of the cloud computing services by a user, the historical usage data covering a defined time period including a plurality of time units, and the historical usage data including information indicative of a number of server instances that were required by the user in each time unit of the time period;
receiving cost information indicative of cost for advance purchase of each reserved instance server and on-demand cost of each on-demand server;
calculating a total cost for usage of a plurality of combinations of reserved instance servers and/or on-demand servers that will satisfy the user's server requirements over the defined time period; and
selecting a recommended number of reserved instance servers to be purchased by the user based on the calculated total cost for the plurality of combinations of reserved instance servers and on-demand servers.

### BRIEF DESCRIPTION OF THE DRAWINGS

The present invention will now be described, by way of example only, with reference to the accompanying drawings, in which:

FIG. 1 is a schematic block diagram of a resource planning system in accordance with an embodiment of the present invention;

FIG. 2 is a table showing an example of cost results for a given historical data set assuming a given selected number of reserved instance (RI) servers and a required number of on-demand (OD) servers;

FIG. 3 is a plot illustrating the total cost based on the selected number of reserved instance (RI) servers and the required number of on-demand (OD) servers shown in the table of FIG. 2; and

FIG. 4 is a flow diagram illustrating a method of planning cloud computing resource requirements in accordance with an embodiment of the present invention.

### DESCRIPTION OF AN EMBODIMENT OF THE PRESENT INVENTION

It should be understood that the specific design features of the resource planning system as disclosed here, including, for example, the specific length of time covered by the historical data, will be determined in part by the particular intended application and use environment.

It will be apparent to those skilled in the art, that is, to those who have knowledge or experience in this area of technology, that many uses and design variations are possible for the described resource planning system and method. The following detailed discussion of various alternate features and embodiments will illustrate the general principles of the invention with reference to a resource planning system and method suitable for use with a cloud computing environment. Other embodiments suitable for other applications will be apparent to those skilled in the art given the benefit of this disclosure.

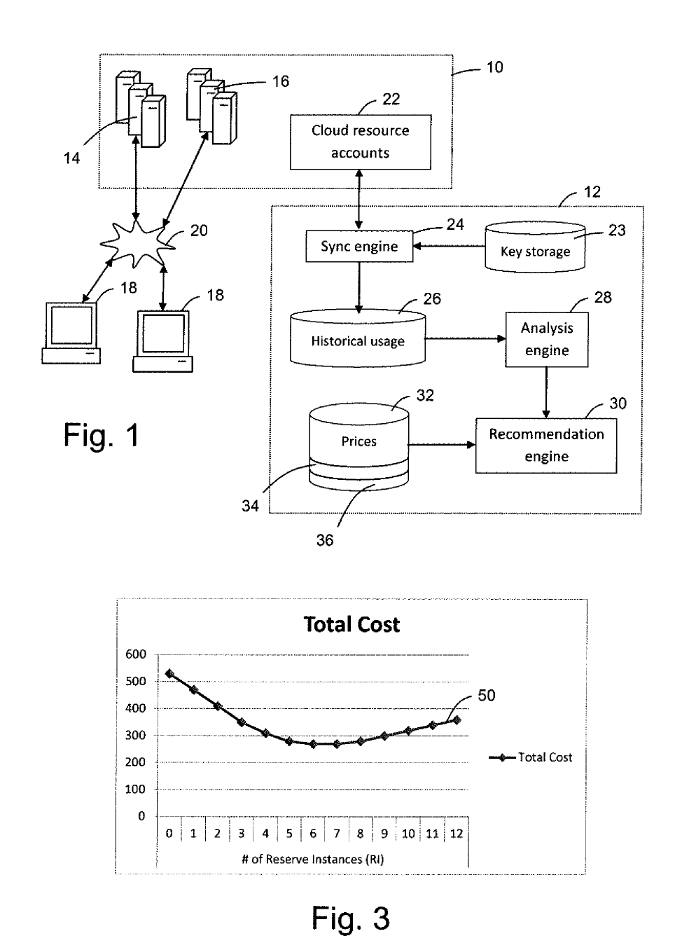

Referring to the drawings, in FIG. 1 a cloud computing system 10 is shown in communication with a resource planning system 12 in accordance with an embodiment of the present invention.

The cloud computing system 10 in this example includes several servers that may be used as reserved instance (RI) servers 14 or on-demand (OD) servers 16. The RI and OD servers 14, 16 are accessible by a plurality of authorised user computing devices 18 through a wide area network such as the Internet 20. The cloud computing system 10 also stores cloud resource account details 22 indicative of a plurality of user accounts associated with users authorised to access the system 10. Each cloud resource account defines the type of access to the servers 14, 16 that the user associated with the account has purchased, and also stores historical data indicative of usage of the servers 14, 16 by the user.

In the present example, the cloud computing system 10 provides infrastructure as a service (laaS) cloud computing to authorised users, although it will be understood that the invention may be applicable to other suitable cloud computing systems.

The resource planning system 12 is arranged to store access details for users authorised to access the cloud computing system 10 in a key storage device 23. A sync engine 24 of the resource planning system 12 accesses the relevant cloud resource account 22 in order to retrieve historical usage data for a user and store the historical usage data in a historical usage database 26. The sync engine 24 may be arranged to do this periodically at defined regular intervals.

In this embodiment, a user is able to define the scope of monitoring of the resource planning system 10 by defining the type and scope of historical usage data to be retrieved by the sync engine 24 from the cloud computing system 10.

The retrieved historical usage data for a user represents a historical usage trend Ω of RI and OD server usage for the user. The historical usage trend Ω specifies the number of servers required for each unit of time in a time period. For example, if the time period is 10 hours, each unit of time may be 1 hour, and the historical usage trend will identify how many servers were required by the user in each hour of the 10 hour time period.

Use of the RI and OD servers 14, 16 by an authorised user is offered in exchange for a fee. In this embodiment, access to servers may be charged in advance for a defined number of servers and a defined period of time, or based on on-demand usage. Servers that are reserved in advance are termed reserved instance (RI) servers 14 and servers that are accessed on-demand are termed on-demand (OD) servers 16.

Typically on-demand payments Q are higher per given unit of time than reserved instance payments R, since reserved instance payments allow for cloud service providers to fill their schedule in advance, as well as adjust and plan their resource availability based on customer demand. While this is advantageous to a provider of cloud services, a user has the potential to overpay by buying more computer time than the user actually requires.

The resource planning system 12 uses the historical usage trend Ω of RI and OD server usage for a user to estimate the most cost effective future server requirements by determining the most likely number of RI servers that will provide the most cost effective RI and OD server offering. The determined most cost effective number of RI servers may then be communicated directly to the relevant cloud resource account 22 of the user, or may be communicated directly to the user, for example by displaying the most cost effective number of RI servers on a screen. In this way, a complex cost benefit analysis can be greatly simplified.

For this purpose, the resource planning system 12 also includes an analysis engine 28 arranged to determine the monitoring scope and retrieve the appropriate historical usage trend Ω from the historical usage database 26. The resource planning system 12 also includes a recommendation engine 30 arranged to calculate the total server usage cost for each time unit in the time period covered by the historical usage trend Ω and for each possible combination of RI servers 14 and OD servers 16, and to then determine the most cost effective number of RI servers 14.

It will be understood that the cloud resource accounts 22 may be realised in any suitable way, for example using a computing device provided with an appropriate processor, memory and suitable software. Similarly, the functional components of the resource planning system 12 may be implemented in any suitable way, for example using a computing device provided with a processor, memory and suitable software.

The resource planning system 12 also includes a prices database 32 that stores information indicative of the RI usage price 34 for RI servers 14 and the OD usage price for OD servers 16.

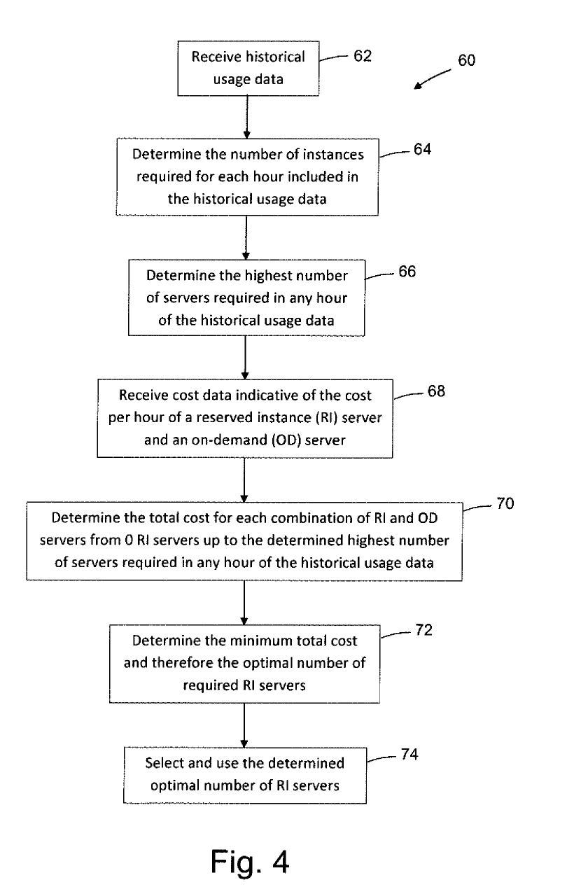

An example will now be described in relation to FIGS. 1 to 3 and FIG. 4 which is a flow diagram 60 showing steps 62 to 74 of a method of planning cloud computing resource requirements.

In this example, the following historical usage trend Ω is provided 62 to the analysis engine 28 for a particular user:
Ω={4, 6, 0, 5, 7, 8, 5, 3, 12, 3}

The example historical usage trend Ω covers a 10 hour time period and each time unit of the time period is 1 hour. Accordingly, for example, in the second time unit 6 servers were required and in the ninth time unit 12 servers were required.

The analysis engine 28 retrieves the appropriate historical usage trend Ω from the historical usage database 26 and determines 64 the number of servers (instances) required for each time unit of the historical data.

As indicated at step 66, the recommendation engine 30 determines the highest number of servers required in any time unit of the historical usage data, in this example 12.

In this example, the cost Q of an on demand server 16 is 10 cost units and the cost R of a reserved instance server 14 is 3 cost units. The respective costs Q, R are retrieved 68 from the prices database 32 by the recommendation engine 30.

The recommendation engine 30 then calculates 70 the total cost for each combination of RI and OD servers 14, 16 in each time unit that will satisfy the server requirement in the time unit. The possible combinations comprise any number of advance paid reserved instance servers from 0 to 12 plus the required number of on-demand servers that are required to satisfy the server requirement in the time unit. For example, in the first time unit, 4 servers were required, so if any more than 4 servers have been paid for in advance, no additional on-demand servers would have been required in the first time unit. Accordingly, in the first time unit, wherein 4 servers are required, the recommendation engine 30 calculates the total server cost for 0 RI servers 14 and 4 OD servers 16, 1 RI server 14 and 3 OD servers 16, 2 RI servers 14 and 2 OD servers 16, 3 RI servers 14 and 1 OD server 16, and each of 4 to 12 RI servers 14 with 0 OD servers 16. The minimum total cost in the first time unit is 12 units, which corresponds to 4 RI servers 14 and 0 OD servers 16.

The following equation represents the calculation carried out by the recommendation engine 30:

TotalCost=((O−z)*Q)+(z*R)

Where O is the number of servers required in a time unit of the time period of the historical usage trend Ω, (O−z)≧0, z is the number of RI servers purchased in a time unit of the time period of the historical usage trend Ω, Q is the cost of an on-demand server, and R is the cost of a reserved instance RI server.

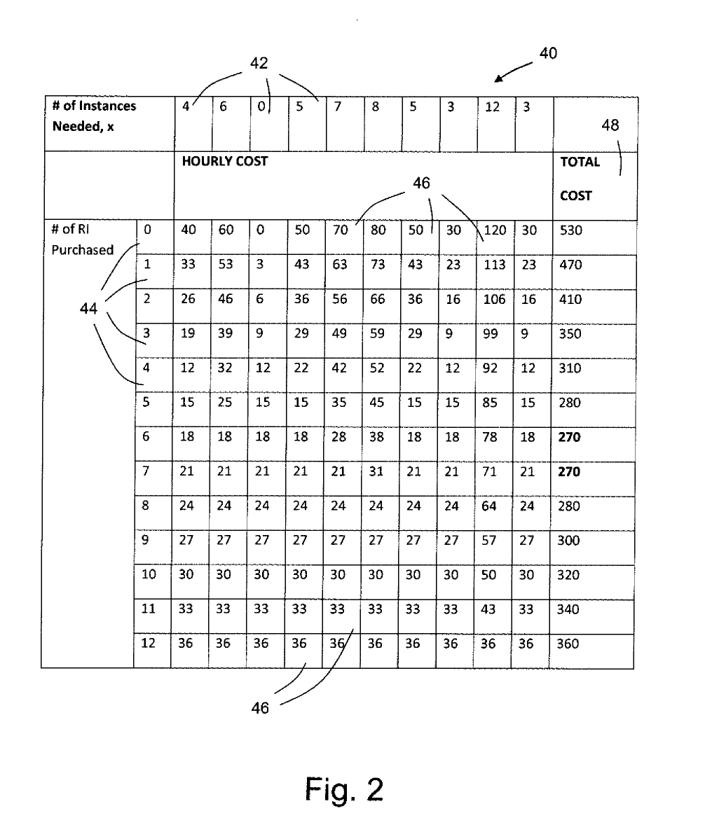

FIG. 2 shows an example table 40 of cost results for the above historical data set for between 0and 12 purchased RI servers.

The table 40 includes required servers columns 42, each column 42 representing the number of servers (instances) required in a particular time unit of the time period covered by the historical usage trend Ω. In this example, each column corresponds to a time unit of 1 hour. The table 40 also includes purchased RI server rows 44, each row 44 representing a number of purchased RI servers 14, and time unit total cost amounts 46 for each combination of purchased number of RI servers 14 and required number of OD servers 16.

For example, in the 4^{th} time unit, 5 servers (instances) are required, and the column 42 corresponding to the 4^{th} time unit shows that the total cost for the 4^{th} time unit if 2 RI servers 14 have been pre-purchased will be 36 cost units. 2 RI servers are 6 cost is units for one time unit and the additional required 3 OD servers 16 are 30 cost units.

The table 40 also includes a total cost column 48 that shows the total cost across the time period, that is, the total cost of all 10 time units of the time period, for each of 0 to 12 RI servers 14.

Referring to FIG. 3, a plot 50 is shown that illustrates the total cost based on the number of reserved instance (RI) servers for the example historical usage trend Ω.

As can be seen from the plot 50 and the total cost column 48 in the table 40 of FIG. 2, the minimum total cost over the time period covered by the historical usage trend Ω is 270 cost units when 6 or 7 RI servers are purchased in advance. Based on this, in the present example, the recommendation engine 30 suggests 72, 74 that 6 RI servers 14 are purchased. The suggested number of RI servers may be communicated automatically to the cloud resource accounts 22 for recordal in the cloud resource account associated with the user, or may be visually communicated to the user, for example by displaying the recommended number of RI servers on a screen, or by displaying a plurality of RI server combinations and highlighting a recommended number of RI servers.

Preferably, the resource planning system 12 may be adapted to work with multiple different servers from different vendors and with different software control modules. That is, the resource planning system 12 is adapted to work with so-called heterogeneous platforms. Also, the resource planner may be incorporated into a system which may also provide security suggestions, other performance enhancements and/or disaster recovery setup.

From the foregoing disclosure and detailed description of certain embodiments, it will be apparent that various modifications, additions and other alternative embodiments are possible without departing from the true scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

Modifications and variations as would be apparent to a skilled addressee are deemed to be within the scope of the present invention.

1. A resource planning system for planning reserved instance server requirements for a user of cloud computing services that comprise reserved instance servers and on-demand servers accessible by the user;
the system arranged to receive historical usage data indicative of a historical usage of the cloud computing services by a user, the historical usage data covering a defined time period including a plurality of time units, and the historical usage data including information indicative of a number of server instances that were required by the user in each time unit of the time period;
to the system arranged to receive cost information indicative of cost for advance purchase of each reserved instance server and on-demand cost of each on-demand server; and
the system arranged to calculate a total cost for usage of a plurality of combinations of reserved instance servers and/or on-demand servers that will satisfy the user's server requirements over the defined time period; and
the system comprising a recommendation engine arranged to select a recommended number of reserved instance servers to be purchased by the user based on the calculated total cost for the plurality of combinations of reserved instance servers and on-demand servers.

2. The resource planning system as claimed in claim 1, wherein the recommendation engine is arranged to select a recommended number of reserved instance servers that correspond to a lowest total cost over the time period.

3. The resource planning system as claimed in claim 1, wherein the system is arranged to display the recommended number of reserved instance servers on a screen.

4. The resource planning system as claimed in claim 3, wherein the system is arranged to highlight the recommended number of reserved instance servers on the screen.

5. The resource planning system as claimed in claim 1, comprising a sync engine arranged to retrieve the historical usage data associated with a user from a cloud resource account associated with the user.

6. The resource planning system as claimed in claim 5, comprising a key storage device arranged to store account access details associated with a user, the account access details usable by the sync engine to access a cloud resource account associated with the user.

7. The resource planning system as claimed in claim 1, comprising a historical usage storage device arranged to store received historical usage data.

8. The resource planning system as claimed in claim 7, comprising an analysis engine arranged to retrieve the historical usage data from the historical usage storage device and determine the total number of servers required for each time unit of the historical data.

9. The resource planning system as claimed in claim 8, wherein the system is arranged to determine the highest number of servers required in any time unit of the historical usage data, and to calculate the total cost for each combination of reserved instance and on-demand servers sufficient to satisfy the required number of servers in each time unit.

10. The resource planning system as claimed in claim 9, wherein the recommendation engine is arranged to calculate the total cost for the plurality of combinations of reserved instance servers and on-demand servers using the following equation:
TotalCost=((O−z)*Q)+(z*R)
where O is the number of servers required in a time unit of the time period of the historical usage trend Ω, (O−z)≧0, z is the number of RI servers purchased in a time unit of the time period of the historical usage trend Ω, Q is the cost of an on-demand server, and R is the cost of a reserved instance RI server.

11. The resource planning system as claimed in claim 1, wherein the cloud computing services comprise infrastructure as a service (laaS).

12. A method of planning reserved instance server requirements for a user of cloud computing services that comprise reserved instance servers and on-demand servers accessible by the user, the method comprising:
receiving historical usage data indicative of a historical usage of the cloud computing services by a user, the historical usage data covering a defined time period including a plurality of time units, and the historical usage data including information indicative of a number of server instances that were required by the user in each time unit of the time period;
receiving cost information indicative of cost for advance purchase of each reserved instance server and on-demand cost of each on-demand server;
calculating a total cost for usage of a plurality of combinations of reserved instance servers and/or on-demand servers that will satisfy the user's server requirements over the defined time period; and
selecting a recommended number of reserved instance servers to be purchased by the user based on the calculated total cost for the plurality of combinations of reserved instance servers and on-demand servers.

13. The method as claimed in claim 12, further comprising selecting a recommended number of reserved instance servers that correspond to a lowest total cost over the time period.

14. The method as claimed in claim 12, further comprising displaying the recommended number of reserved instance servers on a screen.

15. The method as claimed in claim 14, further comprising highlighting the recommended number of reserved instance servers on the screen.

16. The method as claimed in claims 12, further comprising retrieving the historical usage data associated with a user from a cloud resource account associated with the user using a sync engine.

17. The method as claimed in claim 16, further comprising storing account access details associated with a user in a key storage device, the account access details usable by the sync engine to access a cloud resource account associated with the user.

18. The method as claimed in any one of claims 12, further comprising determining the total number of servers required for each time unit of the historical data.

19. The method as claimed in claim 18, further comprising determine the highest number of servers required in any time unit of the historical usage data, and calculating the total cost for each combination of reserved instance and on-demand servers sufficient to satisfy the required number of servers in each time unit.

20. The method as claimed in claim 19, further comprising calculating the total cost for the plurality of combinations of reserved instance servers and on-demand servers using the following equation:
TotalCost=((O−z)*Q)+(z*R)
where O is the number of servers required in a time unit of the time period of the historical usage trend Ω, (O−z)≧0, z is the number of RI servers purchased in a time unit of the time period of the historical usage trend Ω, Q is the cost of an on-demand server, and R is the cost of a reserved instance RI server.

21. The method as claimed in any one of claims 12, wherein the cloud computing services comprise infrastructure as a service (laaS).
